(19) United States
(12) Patent Application Publication
(10) Pub. No.: US 2026/0062768 A1
(43) Pub. Date: Mar. 5, 2026

(54) SYSTEMS AND RELATED METHODS FOR EXTRACTION OF METALS USING CONTINUOUS, ELEVATED PRESSURE CARBONYL PROCESSES

(71) Applicant: Westwin Elements, Inc., Oklahoma City, OK (US)

(72) Inventor: Dmitri S. TEREKHOV, Newmarket (CA)

(73) Assignee: Westwin Elements, Inc., Oklahoma City, OK (US)

(21) Appl. No.: 19/279,298

(22) Filed: Jul. 24, 2025

Related U.S. Application Data
(60) Provisional application No. 63/689,210, filed on Aug. 30, 2024.

(51) Int. Cl. C22B 23/02; B01J 4/00; B01J 8/00; B01J 8/02; B01J 8/08; B01J 8/12; C01G 49/16; C01G 51/02; C01G 53/02; C22B 5/20

(52) U.S. Cl. CPC C22B 23/02; B01J 4/008; B01J 8/003; B01J 8/0278; B01J 8/0285; B01J 8/082; B01J 8/085; B01J 8/087; B01J 8/12; C01G 49/16; C01G 51/02; C01G 53/02; C22B 5/20; B01J 2208/00061; B01J 2208/00212; B01J 2208/00539; B01J 2208/00769; B01J 2208/00938

(57) ABSTRACT

Methods and reactor systems are provided for extracting metals, such as nickel, cobalt, and iron, from reduced, activated metal compounds (“feed materials”). Feed materials may be derived from mixed hydroxide precipitate. Feed materials and carbon monoxide gas are delivered into an extraction reactor of a reactor system, such as a shell tube heat exchanger. A flow path therein directs the feed material downward and the carbon monoxide gas upward, enabling contact therebetween, forming at least one metal carbonyl gas and a solid residue therein. The flow path further directs the upward flow of metal carbonyl gases, and the downward flow of the residue. Methods and reactor systems may further purge the residue: using nitric oxide to convert any remaining dicobalt octacarbonyl therein to cobalt tricarbonyl nitrosyl gas; using an inert gas to removing any cobalt tricarbonyl nitrosyl therein; and using an inert gas-oxygen mixture, to form a passivated residue.

### CROSS REFERENCE TO RELATED APPLICATIONS

The present application claims the benefit of Provisional Application No. 63/689,210, filed Aug. 30, 2024, incorporated by reference in its entirety herein.

### FIELD OF THE DISCLOSURE

The present disclosure relates generally to continuous, elevated pressure carbonyl processes, and, more particularly, to systems and related methods for extraction of metals, such as nickel, cobalt, and iron, using continuous, elevated pressure carbonyl processes.

### BACKGROUND OF THE DISCLOSURE

The carbonyl process of extraction of nickel has been known since the beginning of the 19th century. The carbonyl process separates nickel (Ni) from other metals by passing carbon monoxide (CO) over a heated metal mixture containing nickel, to form a volatile nickel carbonyl (Ni(CO)₄), which is swept away by a gas stream. There are two general methods of nickel extraction using carbonyl technology: atmospheric and elevated pressure. The atmospheric pressure carbonyl process reactor is continuous and designed as a rotary kiln reactor. The feed material, reduced nickel oxide, is purged with inert gas and brought to the reactor from a feed bin using a rotary valve. The residue after extraction is removed from the reactor to the residue bin and purged to remove traces of carbon monoxide and nifluckel carbonyl. A rotary continuous reactor's disadvantages are high maintenance and potential leaks of toxic gases through rotary joins.

Elevated pressure carbonyl operations and related reactors have been designed for batch operation only and may be a rotary or static bed design. Elevated pressure continuous carbonyl process reactors have several challenges, including potential leaks of toxic gases, such as nickel carbonyl, temperature regulation inside the reactor bed, fragility of feed materials, feeding of fed material, and removing of residue from the reactor at high pressure.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, methods for extracting at least one metal compound from a feed material comprise: a) providing each of a reduced feed material (“RF”) comprising at least one reduced metal compound and a reducing agent to a reduced feed material (“RF”) bin; b) heating an interior of the RF bin to a temperature of 130° C. to about 175° C., thereby forming an activated feed material (“AF”) therein; c) purging and pressurizing the RF bin to a pressure about 0.1 Bar to about 1.0 Bar above a pressure of an extraction reactor (“ER”) using an inert gas; d) delivering the AF material to an AF bin, wherein the AF bin is maintained at a pressure about 0.1 Bar to about 1.0 Bar below a pressure of the ER using an inert gas; and c) isolating the RF bin from the AF bin, depressurizing the RF bin, and repeating steps a) to d); f) delivering the AF into an upper end of an extraction reactor (“ER”) and, simultaneously, delivering carbon monoxide gas into a lower end of the ER, wherein the pressure of the ER is maintained at about 5 Bar to about 80 Bar, and wherein the temperature of the ER is maintained at about 60° C. to about 180° C., wherein the ER comprises a flow path directing a downward flow of the AF contrary to an upward flow of the carbon monoxide gas, the flow path enabling the AF to contact the carbon monoxide gas, thereby forming at least one metal carbonyl gas and a solid residue (“R”) therein, and wherein the flow path further directs the upward flow of a produced gas mixture (“PG”) comprising the at least one metal carbonyl gas and, if present, unreacted carbon monoxide gas, and the downward flow of the R; g) delivering the PG from an upper end of the ER out of an PG port, and, simultaneously, delivering the R from a lower end of the ER by feeding the R to an R bin, wherein the R bin is maintained at a pressure about 0.1 Bar to about 1.0 Bar below a pressure of the ER using an inert gas; h) delivering the R to a passivated residue (“PR”) bin, wherein the PR bin is maintained at a pressure about the operation pressure of the ER with an inert gas; i) when the PR bin is full, isolating the PR bin from the R bin and depressurizing the PR bin; j) perform and, if necessary, repeat until all toxic gas has been removed from the PR bin: purging the PR bin using nitric oxide, thereby converting any remaining dicobalt octacarbonyl therein to cobalt tricarbonyl nitrosyl gas; purging the PR bin using an inert gas, thereby removing any volatile cobalt tricarbonyl nitrosyl therein; and purging the PR bin using an inert gas-oxygen mixture, thereby passivating the R therein to form a passivated residue (“PR”); k) removing the PR from the PR bin; and l) purging and pressurizing the PR bin with an inert gas and repeating steps h) to k).

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic side view of a continuous carbonyl process system, according to one or more embodiments of the present disclosure.

FIG. 2 is a flowchart illustrating an example method for performing a continuous carbonyl process, according to one or more embodiments of the present disclosure.

### DETAILED DESCRIPTION

Embodiments in accordance with the present disclosure generally relates to continuous reactor systems and methods of use thereof for extraction of metals from a feed material, and, more particularly, to the extraction of metals such as nickel, cobalt, and iron using elevated temperature and pressure continuous reactors and methods of use thereof.

In an embodiment in accordance with the present disclosure, metal extraction reactor systems comprise: a) one or more reduced feed material (“RF”) bins, wherein each RF bin independently: is capable of receiving a RF comprising at least one reduced metal compound, comprises a RF bin port in fluidic connection with an interior of the RF bin, such that a fluid is enabled to flow into and/or out of the RF bin via said RF bin port, thereby pressurizing, purging, or depressurizing the RF bin comprising a RF material with said fluid, wherein said fluid is independently at each occurrence a reducing agent or an inert gas; and is capable of being heated while comprising a RF material and a reducing agent to a temperature of about 130° C. to about 175° C., thereby converting the RF material therein to an activated feed material (“AF”); b) a RF bin valve, wherein the RF bin valve is capable of providing an independent fluidic connection between an AF bin and each RF bin, while containing the AF, thereby enabling delivery of the AF to the AF bin, and wherein, after delivery of the AF to the AF bin, the fluidic connection is capable of being closed, thereby isolating the RF bin from the AF bin and enabling the depressurization of said isolated RF bin for receiving further RF; c) the AF bin, wherein the AF bin further comprises a AF bin port in fluidic connection with an interior of said AF bin, such that an inert gas is enabled to flow into and/or out of the AF bin, thereby maintaining the pressure within the AF bin at about 0.1 Bar to about 1.0 Bar less than a pressure of an extraction reactor (“ER”); d) an AF bin valve, wherein the AF bin valve is capable of providing fluidic connection between the ER and the activated residue (“AF”) bin while containing the AF, thereby enabling delivery of the AF to the ER; c) an ER, comprising: i. a shell defining the exterior of the ER; a. a carbon monoxide (“CO”) gas inlet port disposed on a surface of the shell at a lower end of the ER, configured to allow a CO gas to flow into the ER; b. a produced gas mixture (“PG”) outlet port disposed on a surface of the shell at an upper end of the extraction reactor, configured to remove “PG” from the ER; c. a heat transfer fluid inlet port disposed on a surface of the shell, configured to allow a heat transfer fluid to flow into the extraction reactor; and d. a heat transfer fluid inlet port disposed on a surface of the shell, configured to allow a heat transfer fluid to flow into the extraction reactor; and ii. a tube bundle comprising a plurality of tubes, wherein the tube bundle is disposed within the interior of shell and fluidically connected to each of the heat transfer fluid inlet port and the heat transfer fluid outlet port, such that a heat transfer fluid is enabled to flow through the tubes; iii. a plurality of thermocouples configured to measure the temperature therein; and iv. a temperature control unit, configured to control the temperature in the interior of the shell by adjusting the temperature of the heat transfer fluid, such that the heat transfer fluid is heated or cooled while flowing through the tube bundle, wherein the temperature control unit maintains the ER at a temperature of about 60° C. to about 180° C.; v. a gas distributor disposed within the interior of the shell, in proximity to and in fluidic connection with the CO gas inlet port, comprising a plurality of apertures configured to allow an upward flow of CO gas within the shell, wherein the shell is maintained at an operating pressure of about 5 Bar to about 80 Bar using the carbon monoxide gas; iv. a flow path disposed within the interior of the shell, wherein the flow path defined by a flow path over the tube bundle therein, and wherein the flow path directs a downward flow of the AF counter to an upward flow of the CO gas within the shell, wherein upon contact of the AF and the CO gas within the shell, one or more metal carbonyl gases and a solid residue (“R”) are formed, and wherein the flow path directs an upward flow of a PG comprising the one or more metal carbonyls and, if present, unreacted CO, and a downward flow of the R; f) an ER outlet valve, wherein the ER outlet bin valve capable of providing fluidic connection between the ER containing the R and an R bin, thereby enabling delivering of the R to the R bin; g) an R bin, wherein the R bin further comprises a R bin port in fluidic connection with an interior of said R bin, such that an inert gas is enabled to flow into and/or out of the R bin, thereby maintaining the pressure within the R bin at about 0.1 Bar to about 1.0 Bar less than the pressure of an extraction reactor (“ER”); h) a R bin valve, wherein the R bin valve capable of providing an independent fluidic connection between the R bin, while containing the R, and each of one or more passivated residue (“PR”) bins, thereby enabling delivering of the R to the PR bin, and wherein, when the PR bin is full, the fluidic connection is capable of being closed, thereby isolating the PR bin containing the R from the R bin; i) one or more PR bins, wherein each PR bin comprises a PR bin port in fluidic connection with an interior of said PR bin, such that a fluid is enabled to flow into and/or out of each PR bin via said PR bin port, thereby pressurizing, purging, or depressurizing each PR bin comprising the R with said fluid, wherein said fluid is independently at each occurrence nitric oxide, an inert gas, or an inert gas-oxygen mixture; and when a PR bin is not isolated from the R bin, inert gas is enabled to flow into and/or out of the PR bin, thereby maintaining the pressure within the PR bin at about the pressure of an extraction reactor (“ER”); and when a PR bin containing the R is isolated from the R bin, the PR bin is capable of being depressurized, purged with nitric oxide (NO), purged with inert gas, and passivated with an inert gas-oxygen mixture, thereby forming PR from the R therein; j) a PR bin outlet valve, wherein the PR bin outlet valve is capable of providing a fluidic connection between the PR bin and the exterior of the reactor system, thereby enabling removal of the PR from the PR bin, and wherein, after removal, the PR bin outlet valve is capable of being closed, thereby enabling the inert gas purging and pressurization of the PR bin for receiving further R.

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

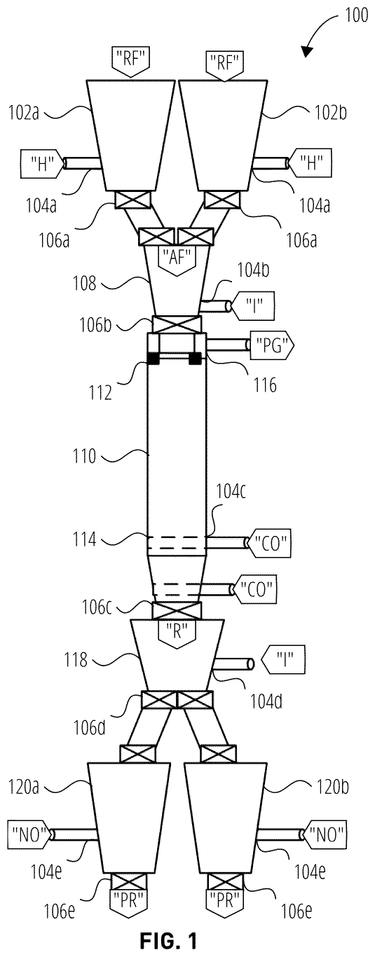

FIG. 1 is a schematic side view of a continuous carbonyl process system 100 for extracting metals, such as nickel, cobalt, iron, and the like, from a reduced feed material “RF”. A reduced feed material “RF” may comprise one or more reduced compounds of one or more metals, such as nickel, cobalt, iron, or the like. A reduced feed material “RF” may be in the form of agglomerated material, such as briquettes or pellets. As used herein, the term “agglomerated material,” and grammatical variations thereof, generally refer to material formed by a process of forming particles into a mass or a cluster by various techniques such sintering, pelletizing, or briquetting to create larger, more manageable forms from fine particles or powders. In various embodiments agglomerated material has a longest length, e.g., a cross-section, a diameter, or the like, of at least about 1 mm, such as at least about 2 mm, or at least about 5 mm. In various embodiments, agglomerated materials in the form of briquettes have a longest length of about 20 mm to about 500 mm, such as about 50 mm to about 300 mm. In various embodiments, agglomerated materials in the form of pellets have a longest length of about 1 mm to about 50 mm, such as about 5 mm to about 20 mm.

In some embodiments, a reduced feed material “RF” may be generated from an oxidized feed material “OF” comprising, e.g., oxides and/or hydroxides of one or more metals, such as nickel, cobalt iron, or the like, via a reduction reaction, e.g., reaction of an oxidized feed material “OF” with a reducing agent, such as, but not limited to, hydrogen “H”. Various oxidized feed material “OF” may be used. Suitable oxidized feed material “OF” may include, but is not limited to, mixed hydroxide precipitate (MHP), roasted mixed sulfide precipitate, roasted nickel matte, nickel oxide, nickel carbonate, nickel hydroxide, nickel chloride, cobalt oxide, cobalt hydroxide, cobalt carbonate, cobalt chloride, and the like, and any combination thereof.

In some embodiments an oxidized feed material “OF” may be generated via various conversion reactions from a precursor feed material “PF” comprising one or more impure metals and/or compounds thereof, such as a metal ore. The metals may comprise nickel, cobalt, iron, or the like. Various precursor fed material “PF” may be used. Suitable precursor feed material “PF” may include, but is not limited to, ores such as pentlandite, millerite, violarite, cobaltite, carrollite, linnacite, limonite, garnierite, heterogenite, saprolite, and the like, and any combination thereof. A conversion reaction may include drying and roasting of a precursor feed material “PF” to convert metallic compounds into metal oxides and/or hydroxides, thereby forming the oxidized feed material “OF”. In some embodiments, an oxidized feed material “OF” or precursor feed material “PF” may be in the form of an aggregated material, such as briquettes or pellets.

Continuous carbonyl process system 100 may include one or more RF bins 102a,b which may receive, e.g., via an opening thereof (not shown), a reduced feed material “RF” for reaction within continuous carbonyl process system 100. RF bins 102a,b may be in fluidic communication with an interior of RF bin ports 104a such that fluids may be transferred in and out of RF bins 102a,b as required. The openings of RF bins 102a,b may be independently scalable, such that RF bins 102a,b may be pressurized by introduction of a fluid via RF bin port 104a or fluidically isolated from AF bin 108 as needed. RF bins 102a, b may be capable of being pressurized above atmospheric pressure up to about the pressure of an extraction reactor 110 of continuous carbonyl process system 100 (e.g., up to about 40 Bar). In operation, first RF bin 102a may receive the reduced feed material “RF” and RF bin port 104a may be used in purging of the feed material “F” to remove any oxygen from within first RF bin 102a. Following purging of oxygen, hydrogen “H” may be introduced to first RF bin 102a via RF bin port 104a, and reduced feed material “RF” may be heated at a temperature of about 100° C. to about 250° C., such as about 130° C. to about 170° C., e.g., by heating the interior of first RF bin 102a at said temperature via, e.g., heaters thereof, thereby forming an activated feed material “AF”.

In some embodiments, following activation, first RF bin 102a may be fed an inert gas via RF bin port 104a to pressurize an activated feed material “AF” to a pressure slightly above a pressure of extraction reactor 110, such as about 0.1 Bar to about 1.0 Bar above the operation pressure of extraction reactor 110. As used herein, the term “inert gas,” and grammatical variations thereof, generally refer to gases that do not readily undergo chemical reactions with other chemical substances and thus do not readily form chemical compounds. Suitable inert gases which may be used in systems and methods of the disclosure are oxygen free. Examples of suitable inert gases include, but are not limited to, nitrogen, helium, argon, and any mixture thereof.

Each of feed bins 102a,b may be independently fluidically connected via an RF bin valve 106a to an AF bin 108. RF bin valve 106a may be a rotary valve, or other valve of similar design, which may provide activated feed material “AF” to AF bin 108 at a constant rate. Activated feed material “AF″” may be fed into AF bin 108 from each of RF bins 102a,b in turn, while the other of RF bins 102a,b is isolated, depressurized, and receives further feed material “F” for activation and pressurization. As such, feed bins 102a,b, may be in constant, cyclical operation to provide a constant stream of activated feed material “AF” to AF bin 108. Continuous carbonyl process system 100 may comprise a control system (not shown) which manages the cyclical operation of RF bins 102a,b.

AF bin 108 may act as a staging buffer for introduction of activated feed material “AF” into an extraction reactor 110. AF bin 108 may be in fluidic communication with an interior of AF bin port 104b, such that an inert gas “I” may be introduced into AF bin 108 to maintain the activated feed material “AF” in at a pressure slightly below a pressure of an extraction reactor 110 of continuous carbonyl process system 100, such as about 0.1 Bar to about 1.0 Bar below the operation pressure of extraction reactor 110. AF bin 108 may be fluidically connected via AF bin valves 106b to extraction reactor 110. AF bin valves 106b may be a rotary valve, or other valve of similar design, which may provide activated feed material “AF” to an upper end of extraction reactor 110 at a constant rate. In some embodiments, AF bin valve 106b may be of a same valve type as 106a, while in further embodiments RF bin valve 106a and AF bin valve 106b are of different valve types.

Extraction reactor 110 may be a shell and tube heat exchanger, or other type of heat exchanger, operable to perform extraction operations on activated feed material “AF” therein. The shell may define an exterior of extraction reactor 110, with a tube bundle housed within (not shown), the tubes having inlet and outlet connections enabling the continuous flow of a heat transfer liquid within said tubes. Within the shell, a shell fluid may flow over the exterior of the tubes. The flow path of the shell fluid around the tube bundle may define a flow path for a reaction within extraction reactor 110. The temperature of the heat transfer liquid may be controlled by a temperature control unit (not shown). Heat transfer between the shell fluid and the heat transfer fluid may be used to maintain extraction reactor 110 at an optimal internal temperature. A plurality of thermocouples 112 may be disposed on or within or connected to the extraction reactor 110, operable to detect and monitor an internal temperature of extraction reactor 110.

Extraction reactor 110 may include one or more carbon monoxide (CO) gas distribution rings 114 at or near a lower end of extraction reactor 110 and operable to circulate a fluid comprising a CO gas in an upward direction. In some embodiments, CO gas distribution rings 114 and extraction reactor 110 may be in fluid communication with distribution ring gas port 104c, which may receive the CO gas therein for transfer into CO gas distribution rings 114. CO gas suitable for use in extraction reactor 110 may be a pure CO gas, such as CO gas having a purity of not less than 95 weight percent (wt. %).

The flow path may direct the downward flow of activated feed material “AF” counter to an upward flow of the carbon monoxide (CO) gas. The operating temperature of extraction reactor 110, e.g., provided by the shell and tube heat exchanger, may be about 60° C. to about 180° C. The operating pressure of extraction reactor 110, provided by the pressure of the CO gas therein, may be about 5 Bar to about 80 Bar. The flow path may form a counter-current moving bed within extraction reactor 110. The counter-current moving bed may enable contact of activated feed material “AF” and CO gas therein, thereby forming, at the pressure and temperature of extraction reactor 110, one or more metal carbonyl gases and a solid residue “R”. The one or more metal carbonyl gases may include, but are not limited to, nickel carbonyl gas, cobalt carbonyl gas, iron carbonyl gas, or any combination thereof.

The flow path may further direct the upward flow of a produced gas mixture “PG” comprising the one or more metal carbonyl gases and, if present, unreacted CO gas. Extraction reactor 110 may further include a PG outlet port 116 at or near a top end of extraction reactor 110, such that any produced gas mixture “PG” may be extracted from extraction reactor 110 for further use and processing. High levels of metals originally present within activated feed material “AF”, such as about 95 weight percent (wt. %) to about 98 wt. % each of the nickel and the iron therein, and about 15 wt. % to about 20 wt. % of the cobalt therein, may be removed from the activated feed material “AF” as metal carbonyl gases in the produced gas mixture “PG”.

The one or more metal carbonyls may be subsequently separated, e.g., by distillation or the like, and nickel, cobalt, and iron may be recovered, e.g., by decomposition of the corresponding metal carbonyl gas. The flow path may also direct the downward flow of the residue “R” toward a lower, e.g., bottom, end of extraction reactor 110. The residue “R” may include any remaining reactants of the activated feed material “AF” for further treatment and disposal. Produced gas mixture “PG” may be removed via PG outlet port 116 and transported out of continuous carbonyl process system 100 for further treatment and use.

Extraction reactor 110 may further include delivering residue “R” via an “ER” valve 106c in fluidic communication with an R bin 118 operable to receive residue “R”. As above, ER outlet valve 106c may be of a same valve type, or different valve type, as RF bin valve 106a and AF bin valve 106b. R bin 118 may include an R bin port 104d in fluidic communication with an interior of R bin 118, such that inert gas “I” may pressurize R bin 118 to a pressure slightly below the pressure of extraction reactor 110, such as about 0.1 Bar to about 1.0 Bar below the operation pressure of extraction reactor 110. As such, residue “R” may remain pressurized while preventing possible backflow from R bin 118 into extraction reactor 110. Residue “R” may be transferred at a constant rate into PR bins 120a,b, each in turn, via a PR bin outlet valve 106c in fluid communication with R bin 118 and independently with PR bins 120a,b. The openings of PR bins 120a,b may be independently scalable, such that PR bins 120a,b can be pressurized by introduction of a fluid via PR bin port 104e or fluidically isolated from R bin 118 as needed. Prior to providing residue “R” to one of PR bins 120a,b, said bin may be pressurized with inert gas “I” to a pressure of about the pressure of extraction reactor 110, such as within about +1.0 Bar of the operation pressure of extraction reactor 110. Residue “R” may be provided into first PR bin 120a until first PR bin 120a is filled with residue “R” and unable to accept further materials. At this point, residue “R” may be instead routed into second PR bin 120b while first PR bin 120a is isolated and depressurized for treatment of residue “R”.

PR bin port 104c may be in further fluid communication with an interior of first PR bin 120a, thus allowing an inlet and outlet into first PR bin 120a of various fluids for treatment of the residue “R”. First PR bin 120a may be purged with nitric oxide “NO” to convert any remaining dicobalt octacarbonyl of the residue “R” into a volatile cobalt tricarbonyl nitrosyl. The nitric oxide “NO” may be received through PR bin port 104c. During nitric oxide “NO” treatment, high levels of cobalt originally present within activated feed material “AF”, such as about 70 wt. % to about 75 wt. % of the cobalt therein, may be removed from the residue “R” as the volatile cobalt tricarbonyl nitrosyl. This volatile cobalt tricarbonyl nitrosyl may be extracted via PR bin port 104e for further use and processing, e.g., for decomposition into cobalt metal. Following reaction of the residue “R” with the nitric oxide “NO”, first PR bin 120a may be further purged with an inert gas and passivated with an inert gas-oxygen mixture, both received via PR bin port 104c, to prepare the cobalt-depleted residue for disposal or recycling or reuse. Passivated residue “R” may comprise various residual metals, for example, when mixed hydroxide precipitate (MHP) is used as the oxidized feed material “OF”, passivated residue “R” may comprise about 5 weight percent (wt. %) to 10 wt. % nickel, and about 5 wt. % cobalt. Passivated residue “R” derived from MHP may also comprise about 30 weight percent (wt. %) manganese, about 5 wt. % zinc, about 2 wt. % to about 3 wt. % of silicon, about 5 wt. % of magnesium, as well as other metals and sulfur in the form of sulfates. The residual reduced metals in passivated residue “R” can be further separated by magnetic or gravity separation. In addition, passivated residue “R” can be purified by one of the hydrometallurgical processes, including but not limited to acid or ammonia leach.

First PR bin 120a may be tested to determine if all toxic gas has been removed therein, such as all CO, NO, cobalt tricarbonyl nitrosyl, or any combination thereof, at which point a passivated residue “PR” may be removed from first PR bin 120a via a PR bin outlet valve 106e. Following removal of passivated residue “PR”, first PR bin 120a may be purged and pressurized to the pressure using an inert gas through PR bin outlet valve 106c, such that first PR bin 120a is ready to receive further residue “R” from R bin 118. Second PR bin 120b may then undergo a similar process to treat, passivate, and remove passivated residue “PR” while first PR bin 120a fills with further residue “R”. As such, PR bins 120a,b, may be in constant, cyclical operation to dispose of a constant stream of passivated residue “PR”. Continuous carbonyl process system 100 may comprise a control system (not shown) which manages the cyclical operation of PR bins 120a,b.

In an embodiment in accordance with the present disclosure, metal extraction methods comprise: a) providing each of a reduced feed material (“RF”) comprising at least one reduced metal compound and a reducing agent to a reduced feed material (“RF”) bin; b) heating an interior of the RF bin to a temperature of 130° C. to about 175° C., thereby forming an activated feed material (“AF”) therein; c) purging and pressurizing the RF bin to a pressure about 0.1 Bar to about 1.0 Bar above a pressure of an extraction reactor (“ER”) using an inert gas; d) delivering the AF material to an AF bin, wherein the AF bin is maintained at a pressure about 0.1 Bar to about 1.0 Bar below a pressure of the ER using an inert gas; and c) isolating the RF bin from the AF bin, depressurizing the RF bin, and repeating steps a) to d); f) delivering the AF into an upper end of an extraction reactor (“ER”) and, simultaneously, delivering carbon monoxide gas into a lower end of the ER, wherein the pressure of the ER is maintained at about 5 Bar to about 80 Bar, and wherein the temperature of the ER is maintained at about 60° C. to about 180° C., wherein the ER comprises a flow path directing a downward flow of the AF contrary to an upward flow of the carbon monoxide gas, the flow path enabling the AF to contact the carbon monoxide gas, thereby forming at least one metal carbonyl gas and a solid residue (“R”) therein, and wherein the flow path further directs the upward flow of a produced gas mixture (“PG”) comprising the at least one metal carbonyl gas and, if present, unreacted carbon monoxide gas, and the downward flow of the R; g) delivering the PG from an upper end of the ER out of an PG port, and, simultaneously, delivering the R from a lower end of the ER by feeding the R to an R bin, wherein the R bin is maintained at a pressure about 0.1 Bar to about 1.0 Bar below a pressure of the ER using an inert gas; h) delivering the R to a passivated residue (“PR”) bin, wherein the PR bin is maintained at a pressure about the operation pressure of the ER with an inert gas; i) when the PR bin is full, isolating the PR bin from the R bin and depressurizing the PR bin; j) perform and, if necessary, repeat until all toxic gas has been removed from the PR bin: purging the PR bin using nitric oxide, thereby converting any remaining dicobalt octacarbonyl therein to cobalt tricarbonyl nitrosyl gas; purging the PR bin using an inert gas, thereby removing any volatile cobalt tricarbonyl nitrosyl therein; and purging the PR bin using an inert gas-oxygen mixture, thereby passivating the R therein to form a passivated residue (“PR”); k) removing the PR from the PR bin; and l) purging and pressurizing the PR bin with an inert gas and repeating steps h) to k).

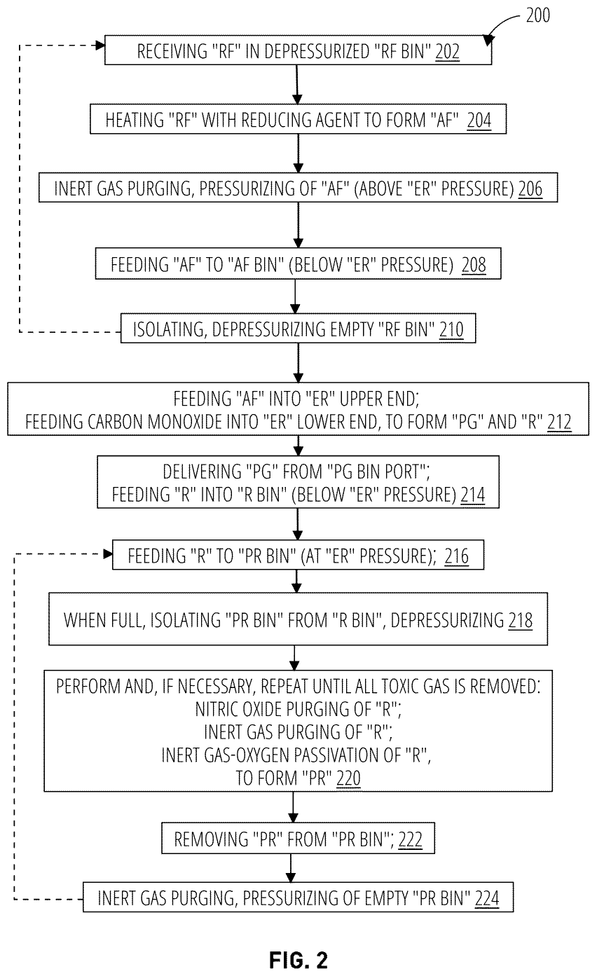

In view of the structural and functional features described above, example methods will be better appreciated with reference to FIG. 2. While, for purposes of simplicity of explanation, the example methods of FIG. 2 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 2 is a flowchart illustrating an example method 200 for extracting nickel, iron, and cobalt in a continuous carbonyl process system, according to one or more embodiments of the present disclosure. The method 200 may be implemented by the continuous carbonyl process system 100 of FIG. 1. Thus, reference may be made to the example of FIG. 1 in the example method 200 of FIG. 2. The method 200 may begin at 202 with receiving reduced feed material “RF” within one or more “RF” feed bins of a continuous carbonyl process system. Reduced feed material “RF” may comprise one or more reduced metal compounds, said metal selected from nickel, cobalt, iron, or the like, or any combination thereof. RF may be agglomerated feed material. In some embodiments, RF may be prepared, prior to method 200, from oxidized feed material “OF”, e.g., comprising metal oxides or hydroxides.

The method 200 may continue at 204 with heating the reduced feed material “RF” at a specific temperature (e.g., about 100° C. to about 250° C.) in the presence of a reducing agent, e.g., hydrogen “H”, thereby forming activated feed material “AF”. The activation of the reduced feed material “RF” at 204 may increase its activity for a subsequent carbonyl process as described herein. In some embodiments, the hydrogen “H”, as well as any purging gases, may be provided via an “RF” feed bin port in fluid communication with the “RF” bins. The method 200 may continue at 206 with purging and pressurizing the RF bins with inert gas to a pressure at or above a reaction operating pressure, e.g., of an extraction reactor. As above, a RF bin port may provide any reducing agent and inert gas used in the activation, purging, and pressurization processes.

Following pressurization of the activated feed material “AF” at 206, the method 200 may continue at 208 with feeding the activated feed material “AF” into an AF bin. The feeding of the activated feed material “AF” into the AF bin at 208 may be facilitated via a RF bin valve in independent fluid communication with each of the RF bins and the AF bin. The RF bin may be maintained with an inert gas at a pressure below the pressure of the extraction reactor. The RF bin valve may be operable to provide the activated feed material “AF” into the AF bin at a constant rate. After providing the activated feed material “AF” to the AF bin, step 210 may include isolating and depressurizing the empty FR feed bin prior to returning to 202 to repeat the cycle of steps 202-210. In embodiments where two or more RF feed bins are included, method 200 may further include performing the cycle of steps 202-210 using each feed bin in turn, such that additional reduced feed material “RF” into one RF feed bin occurs as another RF bin empties into the AF bin. As such, in these cyclical embodiments, a constant flow of activated feed material “AF” may flow into the AF bin and extraction reactor. A controller may be used to control the cyclical steps of 202-210 using a plurality of RF bins.

The method 200 may continue at 212 with feeding activated feed material “AF” into an upper end of the extraction reactor “ER”. In some embodiments, the extraction reactor “ER may be a shell and tube heat exchanger, where the shell defines the exterior of the ER and a tube bundle is disposed within the shell, enabling within each tube the flow of a heat transfer liquid, to maintain an optimal temperature within the extraction reactor. The temperature of the heat transfer fluid may be controlled by a temperature control unit. A plurality of thermocouples may be disposed on or within or connected to the ER, operable to detect and monitor an internal temperature of extraction reactor 110. Simultaneously, at 212, carbon monoxide (“CO”) may be introduced into the extraction reactor in a counter current flow (e.g., activated feed material “AF” may flow downward, while CO flows upward) via one or more gas distribution rings located at or near a bottom of the extraction reactor. In these embodiments, the gas distribution rings may be in fluid communication with a distribution ring gas port for providing the CO to the gas distribution rings. The extraction reactor may be maintained at an operating temperature, via the shell and tube heat exchanger, at about 60° C. to about 180° C., and may be maintained at an operating pressure, via the flow of CO gas, of about 5 Bar to about 80 Bar. Reaction may occur within the extraction reactor at 212 upon contact of the activated feed material “AF” and the CO gas, such that a produced gas mixture “PG” comprising nickel, iron, and cobalt carbonyls and a solid residue “R” may be formed.

The method 200 may continue at 214 with delivery of the PG via an exit port (e.g., PG port) located at or near a top of the extraction reactor and delivering the residue “R” from the extraction reactor by feeding the residue “R” into a R bin via ER output valve for treatment and disposal. The R bin may be maintained with an inert gas at a pressure below the pressure of the ER.

The method may continue at 216 with the feeding of residue “R” into one or more passivated residue “PR” bins at a constant rate via the R bin valve until a PR bin is filled. The PR bin may be maintained with an inert gas at a pressure about the pressure of the ER while residue “R” is being delivered. Once a PR bin is full, at 218, the PR bin is isolated from the R bin. The method 200 may continue at 218 with depressurizing the residue “R” in the PR bin. Next, a series of steps may be performed, and, if necessary, repeated until all toxic gas is removed from the PR bin. The first step in removing the toxic gases includes purging with nitric oxide (e.g., nitric oxide “NO”) to extract further cobalt. The residue “R” received in the R bin may include some remaining dicobalt octacarbonyl which may react with the nitric oxide to create volatile cobalt tricarbonyl nitrosyl. The volatile cobalt tricarbonyl nitrosyl may be extracted via a PR gas port of the PR bin which may also provide the nitric oxide and purging gases to the PR bin. The method 200 may continue at 220 with purging the PR bin with an inert gas, and passivating the purged residue “R” with an inert gas-oxygen mixture. In step 222, the residue “R” thus converted to passivated residue “PR” may be safely disposed following verification of removal of all toxic gas (e.g., CO, NO, cobalt tricarbonyl nitrosyl) from within the first PR bin. The passivated residue “PR” may be removed from the PR bin via a PR output valve for disposal or further processing or use. The passivated residue “PR” may be fully depleted of nickel, iron, and cobalt, and may be ready for safe disposal without risk of operator exposure to toxic gases or high pressures. Following disposal of the passivated residue “PR”, in step 224, the PR bin may be purged and pressurized with inert gas, and method 200 may then continue back to 216 to repeat the cycle of steps 216-224. In embodiments where two or more PR bins are included, method 200 may further performing the cycle of steps 216-224 using each PR bin in turn, such that, for example, a first PR bin receives additional residue “R” while a second PR bin is inert gas purged and pressurized to receive further residue “R”. As such, in these cyclical embodiments, a constant flow of residue “R” may flow out of the ER and the R bin. A controller may be used to control the cyclical steps 216-224 using a plurality of PR bins.

### Example Embodiments

A. Metal Extraction Reactor Systems: Reactor Systems comprise: a) one or more reduced feed material (“RF”) bins, wherein each RF bin independently: is capable of receiving a RF comprising at least one reduced metal compound, comprises a RF bin port in fluidic connection with an interior of the RF bin, such that a fluid is enabled to flow into and/or out of the RF bin via said RF bin port, thereby pressurizing, purging, or depressurizing the RF bin comprising a RF material with said fluid, wherein said fluid is independently at each occurrence a reducing agent or an inert gas; and is capable of being heated while comprising a RF material and a reducing agent to a temperature of about 130° C. to about 175° C., thereby converting the RF material therein to an activated feed material (“AF”); b) a RF bin valve, wherein the RF bin valve is capable of providing an independent fluidic connection between an AF bin and each RF bin, while containing the AF, thereby enabling delivery of the AF to the AF bin, and wherein, after delivery of the AF to the AF bin, the fluidic connection is capable of being closed, thereby isolating the RF bin from the AF bin and enabling the depressurization of said isolated RF bin for receiving further RF; c) the AF bin, wherein the AF bin further comprises a AF bin port in fluidic connection with an interior of said AF bin, such that an inert gas is enabled to flow into and/or out of the AF bin, thereby maintaining the pressure within the AF bin at about 0.1 Bar to about 1.0 Bar less than a pressure of an extraction reactor (“ER”); d) an AF bin valve, wherein the AF bin valve is capable of providing fluidic connection between the ER and the activated residue (“AF”) bin while containing the AF, thereby enabling delivery of the AF to the ER; c) an ER, comprising: i. a shell defining the exterior of the ER; a. a carbon monoxide (“CO”) gas inlet port disposed on a surface of the shell at a lower end of the ER, configured to allow a CO gas to flow into the ER; b. a produced gas mixture (“PG”) outlet port disposed on a surface of the shell at an upper end of the extraction reactor, configured to remove “PG” from the ER; c. a heat transfer fluid inlet port disposed on a surface of the shell, configured to allow a heat transfer fluid to flow into the extraction reactor; and d. a heat transfer fluid inlet port disposed on a surface of the shell, configured to allow a heat transfer fluid to flow into the extraction reactor; and ii. a tube bundle comprising a plurality of tubes, wherein the tube bundle is disposed within the interior of shell and fluidically connected to each of the heat transfer fluid inlet port and the heat transfer fluid outlet port, such that a heat transfer fluid is enabled to flow through the tubes; iii. a plurality of thermocouples configured to measure the temperature therein; and iv. a temperature control unit, configured to control the temperature in the interior of the shell by adjusting the temperature of the heat transfer fluid, such that the heat transfer fluid is heated or cooled while flowing through the tube bundle, wherein the temperature control unit maintains the ER at a temperature of about 60° C. to about 180° C.; v. a gas distributor disposed within the interior of the shell, in proximity to and in fluidic connection with the CO gas inlet port, comprising a plurality of apertures configured to allow an upward flow of CO gas within the shell, wherein the shell is maintained at an operating pressure of about 5 Bar to about 80 Bar using the carbon monoxide gas; iv. a flow path disposed within the interior of the shell, wherein the flow path defined by a flow path over the tube bundle therein, and wherein the flow path directs a downward flow of the AF counter to an upward flow of the CO gas within the shell, wherein upon contact of the AF and the CO gas within the shell, one or more metal carbonyl gases and a solid residue (“R”) are formed, and wherein the flow path directs an upward flow of a PG comprising the one or more metal carbonyls and, if present, unreacted CO, and a downward flow of the R; f) an ER outlet valve, wherein the ER outlet bin valve capable of providing fluidic connection between the ER containing the R and an R bin, thereby enabling delivering of the R to the R bin; g) an R bin, wherein the R bin further comprises a R bin port in fluidic connection with an interior of said R bin, such that an inert gas is enabled to flow into and/or out of the R bin, thereby maintaining the pressure within the R bin at about 0.1 Bar to about 1.0 Bar less than the pressure of an extraction reactor (“ER”); h) a R bin valve, wherein the R bin valve capable of providing an independent fluidic connection between the R bin, while containing the R, and each of one or more passivated residue (“PR”) bins, thereby enabling delivering of the R to the PR bin, and wherein, when the PR bin is full, the fluidic connection is capable of being closed, thereby isolating the PR bin containing the R from the R bin; i) one or more PR bins, wherein each PR bin comprises a PR bin port in fluidic connection with an interior of said PR bin, such that a fluid is enabled to flow into and/or out of each PR bin via said PR bin port, thereby pressurizing, purging, or depressurizing each PR bin comprising the R with said fluid, wherein said fluid is independently at each occurrence nitric oxide, an inert gas, or an inert gas-oxygen mixture; and when a PR bin is not isolated from the R bin, inert gas is enabled to flow into and/or out of the PR bin, thereby maintaining the pressure within the PR bin at about the pressure of an extraction reactor (“ER”); and when a PR bin containing the R is isolated from the R bin, the PR bin is capable of being depressurized, purged with nitric oxide (NO), purged with inert gas, and passivated with an inert gas-oxygen mixture, thereby forming PR from the R therein; j) a PR bin outlet valve, wherein the PR bin outlet valve is capable of providing a fluidic connection between the PR bin and the exterior of the reactor system, thereby enabling removal of the PR from the PR bin, and wherein, after removal, the PR bin outlet valve is capable of being closed, thereby enabling the inert gas purging and pressurization of the PR bin for receiving further R.

B. Metal Extraction Methods. The methods include: a) providing each of a reduced feed material (“RF”) comprising at least one reduced metal compound and a reducing agent to a reduced feed material (“RF”) bin; b) heating an interior of the RF bin to a temperature of 130° C. to about 175° C., thereby forming an activated feed material (“AF”) therein; c) purging and pressurizing the RF bin to a pressure about 0.1 Bar to about 1.0 Bar above a pressure of an extraction reactor (“ER”) using an inert gas; d) delivering the AF material to an AF bin, wherein the AF bin is maintained at a pressure about 0.1 Bar to about 1.0 Bar below a pressure of the ER using an inert gas; and e) isolating the RF bin from the AF bin, depressurizing the RF bin, and repeating steps a) to d); f) delivering the AF into an upper end of an extraction reactor (“ER”) and, simultaneously, delivering carbon monoxide gas into a lower end of the ER, wherein the pressure of the ER is maintained at about 5 Bar to about 80 Bar, and wherein the temperature of the ER is maintained at about 60° C. to about 180° C., wherein the ER comprises a flow path directing a downward flow of the AF contrary to an upward flow of the carbon monoxide gas, the flow path enabling the AF to contact the carbon monoxide gas, thereby forming at least one metal carbonyl gas and a solid residue (“R”) therein, and wherein the flow path further directs the upward flow of a produced gas mixture (“PG”) comprising the at least one metal carbonyl gas and, if present, unreacted carbon monoxide gas, and the downward flow of the R; g) delivering the PG from an upper end of the ER out of an PG port, and, simultaneously, delivering the R from a lower end of the ER by feeding the R to an R bin, wherein the R bin is maintained at a pressure about 0.1 Bar to about 1.0 Bar below a pressure of the ER using an inert gas; h) delivering the R to a passivated residue (“PR”) bin, wherein the PR bin is maintained at a pressure about the operation pressure of the ER with an inert gas; i) when the PR bin is full, isolating the PR bin from the R bin and depressurizing the PR bin; j) perform and, if necessary, repeat until all toxic gas has been removed from the PR bin: purging the PR bin using nitric oxide, thereby converting any remaining dicobalt octacarbonyl therein to cobalt tricarbonyl nitrosyl gas; purging the PR bin using an inert gas, thereby removing any volatile cobalt tricarbonyl nitrosyl therein; and purging the PR bin using an inert gas-oxygen mixture, thereby passivating the R therein to form a passivated residue (“PR”); k) removing the PR from the PR bin; and l) purging and pressurizing the PR bin with an inert gas and repeating steps h) to k).

Each of embodiment A or B may have one or more of the following additional elements in combination.

Element 1: wherein the reactor system comprises two or more RF bins capable of operating in series.

Element 2: wherein the reactor system comprises a control system to control the operation of the two or more RF bins.

Element 3: wherein the reactor system comprises two or more PR bins capable of operating in series.

Element 4: wherein the reactor system comprises a control system to control the operation of the two or more PR bins.

Element 5: wherein at least one of the RF bin valve, the AF bin valve, the ER outlet valve, the R bin valve, and the PR bin outlet valve is a rotary valve.

Element 6: wherein the metal comprises nickel and at least one metal selected from the group consisting of iron, cobalt, and any combination thereof.

Element 7: wherein the RF is dried and/or agglomerated RF optionally comprising briquettes and/or pellets.

Element 8: wherein the reactor system further comprises at least one reactor capable of: reacting an oxidized feed material (“OF”) comprising at least one oxidized metal compound with a reducing agent therein at a sufficient temperature and for a sufficient time, thereby forming the RF; separating nickel carbonyl gas, cobalt carbonyl gas, iron carbonyl gas, or any combination thereof, from the PG; and converting the nickel carbonyl gas, cobalt carbonyl gas, iron carbonyl gas, or any combination into the corresponding metal; and/or collecting any cobalt tricarbonyl nitrosyl purged from the PR bin; and comprising converting any collected cobalt tricarbonyl nitrosyl into cobalt.

Element 9: wherein the OF comprises mixed hydroxide precipitate (MHP).

Element 10: wherein steps a) to d) are performed using a plurality of RF bins each in turn.

Element 11: wherein the method further comprises using a controller to control the cycle of steps a) to d) using the plurality of RF bins.

Element 12: wherein steps h) to k) are performed using a plurality of PR bins each in turn.

Element 13: wherein the method further comprises using a controller to control the cycle of steps h) to k) using the plurality of PR bins.

Element 14: wherein the metal comprises nickel and at least one metal selected from the group consisting of iron, cobalt, and any combination thereof.

Element 15: wherein the reduced feed material is an agglomerated feed material, optionally in the form of briquettes and/or pellets.

Element 16: wherein the extraction reactor is a shell and tube heat exchanger.

Element 17: wherein the method further comprises: prior to providing the RF, preparing the RF, wherein preparing the RF comprises: providing an oxidized feed material (“OF”) comprising at least one oxidized metal compound; and contacting the OF with a reducing agent at a sufficient temperature and for a sufficient time to reduce the OF, thereby forming the RF; separating nickel carbonyl gas, cobalt carbonyl gas, iron carbonyl gas, or any combination thereof, from the PG; and converting the nickel carbonyl gas, cobalt carbonyl gas, iron carbonyl gas, or any combination into the corresponding metal; and/or collecting any cobalt tricarbonyl nitrosyl purged from the PR bin; and comprising converting any collected cobalt tricarbonyl nitrosyl into cobalt.

Element 18: wherein the OF comprises mixed hydroxide precipitate (MHP).

Exemplary combinations applicable to A and B include, but are not limited to, 1 and 2; 1-3; 1-4; 1-5; 1-6; 1-7; 1-8; 1-9; 2 and 3; 4 and 5; 8 and 9; 10 and 11; 10-12; 10-13; 10-14; 10-15; 10-16; 10-17; 10-18, 11 and 12, 13 and 14; 17 and 18.

The present disclosure is further directed to the following non-limiting embodiments.

Embodiment 1. A reactor system for extracting at least one metal compound from a feed material, the reactor system comprising: a) one or more reduced feed material (“RF”) bins, wherein each RF bin independently: is capable of receiving a RF comprising at least one reduced metal compound, comprises a RF bin port in fluidic connection with an interior of the RF bin, such that a fluid is enabled to flow into and/or out of the RF bin via said RF bin port, thereby pressurizing, purging, or depressurizing the RF bin comprising a RF material with said fluid, wherein said fluid is independently at each occurrence a reducing agent or an inert gas; and is capable of being heated while comprising a RF material and a reducing agent to a temperature of about 130° C. to about 175° C., thereby converting the RF material therein to an activated feed material (“AF”); b) a RF bin valve, wherein the RF bin valve is capable of providing an independent fluidic connection between an AF bin and each RF bin, while containing the AF, thereby enabling delivery of the AF to the AF bin, and wherein, after delivery of the AF to the AF bin, the fluidic connection is capable of being closed, thereby isolating the RF bin from the AF bin and enabling the depressurization of said isolated RF bin for receiving further RF; c) the AF bin, wherein the AF bin further comprises a AF bin port in fluidic connection with an interior of said AF bin, such that an inert gas is enabled to flow into and/or out of the AF bin, thereby maintaining the pressure within the AF bin at about 0.1 Bar to about 1.0 Bar less than a pressure of an extraction reactor (“ER”); d) an AF bin valve, wherein the AF bin valve is capable of providing fluidic connection between the ER and the activated residue (“AF”) bin while containing the AF, thereby enabling delivery of the AF to the ER; c) an ER, comprising: i. a shell defining the exterior of the ER; a. a carbon monoxide (“CO”) gas inlet port disposed on a surface of the shell at a lower end of the ER, configured to allow a CO gas to flow into the ER; b. a produced gas mixture (“PG”) outlet port disposed on a surface of the shell at an upper end of the extraction reactor, configured to remove “PG” from the ER; c. a heat transfer fluid inlet port disposed on a surface of the shell, configured to allow a heat transfer fluid to flow into the extraction reactor; and d. a heat transfer fluid inlet port disposed on a surface of the shell, configured to allow a heat transfer fluid to flow into the extraction reactor; and ii. a tube bundle comprising a plurality of tubes, wherein the tube bundle is disposed within the interior of shell and fluidically connected to each of the heat transfer fluid inlet port and the heat transfer fluid outlet port, such that a heat transfer fluid is enabled to flow through the tubes; iii. a plurality of thermocouples configured to measure the temperature therein; and iv. a temperature control unit, configured to control the temperature in the interior of the shell by adjusting the temperature of the heat transfer fluid, such that the heat transfer fluid is heated or cooled while flowing through the tube bundle, wherein the temperature control unit maintains the ER at a temperature of about 60° C. to about 180° C.; v. a gas distributor disposed within the interior of the shell, in proximity to and in fluidic connection with the CO gas inlet port, comprising a plurality of apertures configured to allow an upward flow of CO gas within the shell, wherein the shell is maintained at an operating pressure of about 5 Bar to about 80 Bar using the carbon monoxide gas; iv. a flow path disposed within the interior of the shell, wherein the flow path defined by a flow path over the tube bundle therein, and wherein the flow path directs a downward flow of the AF counter to an upward flow of the CO gas within the shell, wherein upon contact of the AF and the CO gas within the shell, one or more metal carbonyl gases and a solid residue (“R”) are formed, and wherein the flow path directs an upward flow of a PG comprising the one or more metal carbonyls and, if present, unreacted CO, and a downward flow of the R; f) an ER outlet valve, wherein the ER outlet bin valve capable of providing fluidic connection between the ER containing the R and an R bin, thereby enabling delivering of the R to the R bin; g) an R bin, wherein the R bin further comprises a R bin port in fluidic connection with an interior of said R bin, such that an inert gas is enabled to flow into and/or out of the R bin, thereby maintaining the pressure within the R bin at about 0.1 Bar to about 1.0 Bar less than the pressure of an extraction reactor (“ER”); h) a R bin valve, wherein the R bin valve capable of providing an independent fluidic connection between the R bin, while containing the R, and each of one or more passivated residue (“PR”) bins, thereby enabling delivering of the R to the PR bin, and wherein, when the PR bin is full, the fluidic connection is capable of being closed, thereby isolating the PR bin containing the R from the R bin; i) one or more PR bins, wherein each PR bin comprises a PR bin port in fluidic connection with an interior of said PR bin, such that a fluid is enabled to flow into and/or out of each PR bin via said PR bin port, thereby pressurizing, purging, or depressurizing each PR bin comprising the R with said fluid, wherein said fluid is independently at each occurrence nitric oxide, an inert gas, or an inert gas-oxygen mixture; and when a PR bin is not isolated from the R bin, inert gas is enabled to flow into and/or out of the PR bin, thereby maintaining the pressure within the PR bin at about the pressure of an extraction reactor (“ER”); and when a PR bin containing the R is isolated from the R bin, the PR bin is capable of being depressurized, purged with nitric oxide (NO), purged with inert gas, and passivated with an inert gas-oxygen mixture, thereby forming PR from the R therein; j) a PR bin outlet valve, wherein the PR bin outlet valve is capable of providing a fluidic connection between the PR bin and the exterior of the reactor system, thereby enabling removal of the PR from the PR bin, and wherein, after removal, the PR bin outlet valve is capable of being closed, thereby enabling the inert gas purging and pressurization of the PR bin for receiving further R.

Embodiment 2. The reactor system of Embodiment 1, wherein the reactor system comprises two or more RF bins capable of operating in series.

Embodiment 3. The reactor system of Embodiment 2, wherein the reactor system comprises a control system to control the operation of the two or more RF bins.

Embodiment 4. The reactor system of any one of Embodiments 1 to 3, wherein the reactor system comprises two or more PR bins capable of operating in series.

Embodiment 5. The reactor system of Embodiment 4, wherein the reactor system comprises a control system to control the operation of the two or more PR bins.

Embodiment 6. The reactor system of any one of Embodiments 1 to 5, wherein at least one of the RF bin valve, the AF bin valve, the ER outlet valve, the R bin valve, and the PR bin outlet valve is a rotary valve.

Embodiment 7. The reactor system of any one of Embodiments 1 to 6, wherein the metal comprises nickel and at least one metal selected from the group consisting of iron, cobalt, and any combination thereof.

Embodiment 8. The reactor system of any one of Embodiments 1 to 7, wherein the RF is dried and/or agglomerated RF optionally comprising briquettes and/or pellets.

Embodiment 9. The reactor system of any one of Embodiments 1 to 8, wherein the reactor system further comprises at least one reactor capable of: reacting an oxidized feed material (“OF”) comprising at least one oxidized metal compound with a reducing agent therein at a sufficient temperature and for a sufficient time, thereby forming the RF; separating nickel carbonyl gas, cobalt carbonyl gas, iron carbonyl gas, or any combination thereof, from the PG; and converting the nickel carbonyl gas, cobalt carbonyl gas, iron carbonyl gas, or any combination into the corresponding metal; and/or collecting any cobalt tricarbonyl nitrosyl purged from the PR bin; and comprising converting any collected cobalt tricarbonyl nitrosyl into cobalt.

Embodiment 10. The reactor system of Embodiment 9, wherein the OF comprises mixed hydroxide precipitate (MHP).

Embodiment 11. A method comprising: a) providing each of a reduced feed material (“RF”) comprising at least one reduced metal compound and a reducing agent to a reduced feed material (“RF”) bin; b) heating an interior of the RF bin to a temperature of 130° C. to about 175° C., thereby forming an activated feed material (“AF”) therein; c) purging and pressurizing the RF bin to a pressure about 0.1 Bar to about 1.0 Bar above a pressure of an extraction reactor (“ER”) using an inert gas; d) delivering the AF material to an AF bin, wherein the AF bin is maintained at a pressure about 0.1 Bar to about 1.0 Bar below a pressure of the ER using an inert gas; and e) isolating the RF bin from the AF bin, depressurizing the RF bin, and repeating steps a) to d); f) delivering the AF into an upper end of an extraction reactor (“ER”) and, simultaneously, delivering carbon monoxide gas into a lower end of the ER, wherein the pressure of the ER is maintained at about 5 Bar to about 80 Bar, and wherein the temperature of the ER is maintained at about 60° C. to about 180° C., wherein the ER comprises a flow path directing a downward flow of the AF contrary to an upward flow of the carbon monoxide gas, the flow path enabling the AF to contact the carbon monoxide gas, thereby forming at least one metal carbonyl gas and a solid residue (“R”) therein, and wherein the flow path further directs the upward flow of a produced gas mixture (“PG”) comprising the at least one metal carbonyl gas and, if present, unreacted carbon monoxide gas, and the downward flow of the R; g) delivering the PG from an upper end of the ER out of an PG port, and, simultaneously, delivering the R from a lower end of the ER by feeding the R to an R bin, wherein the R bin is maintained at a pressure about 0.1 Bar to about 1.0 Bar below a pressure of the ER using an inert gas; h) delivering the R to a passivated residue (“PR”) bin, wherein the PR bin is maintained at a pressure about the operation pressure of the ER with an inert gas; i) when the PR bin is full, isolating the PR bin from the R bin and depressurizing the PR bin; j) perform and, if necessary, repeat until all toxic gas has been removed from the PR bin: purging the PR bin using nitric oxide, thereby converting any remaining dicobalt octacarbonyl therein to cobalt tricarbonyl nitrosyl gas; purging the PR bin using an inert gas, thereby removing any volatile cobalt tricarbonyl nitrosyl therein; and purging the PR bin using an inert gas-oxygen mixture, thereby passivating the R therein to form a passivated residue (“PR”); k) removing the PR from the PR bin; and l) purging and pressurizing the PR bin with an inert gas and repeating steps h) to k).

Embodiment 12. The method of Embodiment 11, wherein steps a) to d) are performed using a plurality of RF bins each in turn.

Embodiment 13. The method of Embodiment 12, wherein the method further comprises using a controller to control the cycle of steps a) to d) using the plurality of RF bins.

Embodiment 14. The method of any one of Embodiments 11 to 13, wherein steps h) to k) are performed using a plurality of PR bins each in turn.

Embodiment 15. The method of Embodiment 14, wherein the method further comprises using a controller to control the cycle of steps h) to k) using the plurality of PR bins.

Embodiment 16. The method of any one of Embodiments 1 to 5, wherein the metal comprises nickel and at least one metal selected from the group consisting of iron, cobalt, and any combination thereof.

Embodiment 17. The method of any one of Embodiments 11 to 16, wherein the reduced feed material is an agglomerated feed material, optionally in the form of briquettes and/or pellets.

Embodiment 18. The method of any one of Embodiments 11 to 17, wherein the extraction reactor is a shell and tube heat exchanger.

Embodiment 19. The method of any one of Embodiments 11 to 18, wherein the method further comprises: prior to providing the RF, preparing the RF, wherein preparing the RF comprises: providing an oxidized feed material (“OF”) comprising at least one oxidized metal compound; and contacting the OF with a reducing agent at a sufficient temperature and for a sufficient time to reduce the OF, thereby forming the RF; separating nickel carbonyl gas, cobalt carbonyl gas, iron carbonyl gas, or any combination thereof, from the PG; and converting the nickel carbonyl gas, cobalt carbonyl gas, iron carbonyl gas, or any combination into the corresponding metal; and/or collecting any cobalt tricarbonyl nitrosyl purged from the PR bin; and comprising converting any collected cobalt tricarbonyl nitrosyl into cobalt.

Embodiment 20. The method of Embodiment 19, wherein the OF comprises mixed hydroxide precipitate (MHP).

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A reactor system for extracting at least one metal compound from a feed material, the reactor system comprising:
a) one or more reduced feed material (“RF”) bins,
wherein each RF bin independently:
is capable of receiving a RF comprising at least one reduced metal compound,
comprises a RF bin port in fluidic connection with an interior of the RF bin, such that a fluid is enabled to flow into and/or out of the RF bin via said RF bin port, thereby pressurizing, purging, or depressurizing the RF bin comprising a RF material with said fluid, wherein said fluid is independently at each occurrence a reducing agent or an inert gas; and
is capable of being heated while comprising a RF material and a reducing agent to a temperature of about 130° C. to about 175° C., thereby converting the RF material therein to an activated feed material (“AF”);
b) a RF bin valve,
wherein the RF bin valve is capable of providing an independent fluidic connection between an AF bin and each RF bin, while containing the AF, thereby enabling delivery of the AF to the AF bin, and wherein, after delivery of the AF to the AF bin, the fluidic connection is capable of being closed, thereby isolating the RF bin from the AF bin and enabling the depressurization of said isolated RF bin for receiving further RF;
c) the AF bin,
wherein the AF bin further comprises a AF bin port in fluidic connection with an interior of said AF bin, such that an inert gas is enabled to flow into and/or out of the AF bin, thereby maintaining the pressure within the AF bin at about 0.1 Bar to about 1.0 Bar less than a pressure of an extraction reactor (“ER”);
d) an AF bin valve,
wherein the AF bin valve is capable of providing fluidic connection between the ER and the activated residue (“AF”) bin while containing the AF, thereby enabling delivery of the AF to the ER;
e) an ER, comprising:
i. a shell defining the exterior of the ER;
a. a carbon monoxide (“CO”) gas inlet port disposed on a surface of the shell at a lower end of the ER, configured to allow a CO gas to flow into the ER;
b. a produced gas mixture (“PG”) outlet port disposed on a surface of the shell at an upper end of the extraction reactor, configured to remove “PG” from the ER;
c. a heat transfer fluid inlet port disposed on a surface of the shell,
configured to allow a heat transfer fluid to flow into the extraction reactor; and
d. a heat transfer fluid inlet port disposed on a surface of the shell,
configured to allow a heat transfer fluid to flow into the extraction reactor; and
ii. a tube bundle comprising a plurality of tubes, wherein the tube bundle is disposed within the interior of shell and fluidically connected to each of the heat transfer fluid inlet port and the heat transfer fluid outlet port, such that a heat transfer fluid is enabled to flow through the tubes;
iii. a plurality of thermocouples configured to measure the temperature therein; and
iv. a temperature control unit, configured to control the temperature in the interior of the shell by adjusting the temperature of the heat transfer fluid, such that the heat transfer fluid is heated or cooled while flowing through the tube bundle, wherein the temperature control unit maintains the ER at a temperature of about 60° C. to about 180° C.;
v. a gas distributor disposed within the interior of the shell, in proximity to and in fluidic connection with the CO gas inlet port, comprising a plurality of apertures configured to allow an upward flow of CO gas within the shell, wherein the shell is maintained at an operating pressure of about 5 Bar to about 80 Bar using the carbon monoxide gas;
iv. a flow path disposed within the interior of the shell,
wherein the flow path defined by a flow path over the tube bundle therein, and
wherein the flow path directs a downward flow of the AF counter to an upward flow of the CO gas within the shell, wherein upon contact of the AF and the CO gas within the shell, one or more metal carbonyl gases and a solid residue (“R”) are formed, and
wherein the flow path directs an upward flow of a PG comprising the one or more metal carbonyls and, if present, unreacted CO, and a downward flow of the R;
f) an ER outlet valve,
wherein the ER outlet bin valve capable of providing fluidic connection between the ER containing the R and an R bin, thereby enabling delivering of the R to the R bin;
g) an R bin,
wherein the R bin further comprises a R bin port in fluidic connection with an interior of said R bin, such that an inert gas is enabled to flow into and/or out of the R bin, thereby maintaining the pressure within the R bin at about 0.1 Bar to about 1.0 Bar less than the pressure of an extraction reactor (“ER”);
h) a R bin valve,
wherein the R bin valve capable of providing an independent fluidic connection between the R bin, while containing the R, and each of one or more passivated residue (“PR”) bins, thereby enabling delivering of the R to the PR bin, and wherein, when the PR bin is full, the fluidic connection is capable of being closed, thereby isolating the PR bin containing the R from the R bin;
i) one or more PR bins,
wherein each PR bin comprises a PR bin port in fluidic connection with an interior of said PR bin, such that a fluid is enabled to flow into and/or out of each PR bin via said PR bin port, thereby pressurizing, purging, or depressurizing each PR bin comprising the R with said fluid, wherein said fluid is independently at each occurrence nitric oxide, an inert gas, or an inert gas-oxygen mixture; and
when a PR bin is not isolated from the R bin, inert gas is enabled to flow into and/or out of the PR bin, thereby maintaining the pressure within the PR bin at about the pressure of an extraction reactor (“ER”); and
when a PR bin containing the R is isolated from the R bin, the PR bin is capable of being depressurized, purged with nitric oxide (NO), purged with inert gas, and passivated with an inert gas-oxygen mixture, thereby forming PR from the R therein;
j) a PR bin outlet valve,
wherein the PR bin outlet valve is capable of providing a fluidic connection between the PR bin and the exterior of the reactor system, thereby enabling removal of the PR from the PR bin, and
wherein, after removal, the PR bin outlet valve is capable of being closed, thereby enabling the inert gas purging and pressurization of the PR bin for receiving further R.

2. The reactor system of claim 1, wherein the reactor system comprises two or more RF bins capable of operating in series.

3. The reactor system of claim 2, wherein the reactor system comprises a control system to control the operation of the two or more RF bins.

4. The reactor system of claim 1, wherein the reactor system comprises two or more PR bins capable of operating in series.

5. The reactor system of claim 4, wherein the reactor system comprises a control system to control the operation of the two or more PR bins.

6. The reactor system of claim 1, wherein at least one of the RF bin valve, the AF bin valve, the ER outlet valve, the R bin valve, and the PR bin outlet valve is a rotary valve.

7. The reactor system of claim 1, wherein the metal comprises nickel and at least one metal selected from the group consisting of iron, cobalt, and any combination thereof.

8. The reactor system of claim 1, wherein the RF is dried and/or agglomerated RF optionally comprising briquettes and/or pellets.

9. The reactor system of claim 1, wherein the reactor system further comprises at least one reactor capable of:
reacting an oxidized feed material (“OF”) comprising at least one oxidized metal compound with a reducing agent therein at a sufficient temperature and for a sufficient time, thereby forming the RF;
separating nickel carbonyl gas, cobalt carbonyl gas, iron carbonyl gas, or any combination thereof, from the PG; and converting the nickel carbonyl gas, cobalt carbonyl gas, iron carbonyl gas, or any combination into the corresponding metal; and/or
collecting any cobalt tricarbonyl nitrosyl purged from the PR bin; and comprising converting any collected cobalt tricarbonyl nitrosyl into cobalt.

10. The reactor system of claim 9, wherein the OF comprises mixed hydroxide precipitate (MHP).

11. A method for extracting at least one metal compound from a feed material, the method comprising:
a) providing each of a reduced feed material (“RF”) comprising at least one reduced metal compound and a reducing agent to a reduced feed material (“RF”) bin;
b) heating an interior of the RF bin to a temperature of 130° C. to about 175° C., thereby forming an activated feed material (“AF”) therein;
c) purging and pressurizing the RF bin to a pressure about 0.1 Bar to about 1.0 Bar above a pressure of an extraction reactor (“ER”) using an inert gas;
d) delivering the AF material to an AF bin, wherein the AF bin is maintained at a pressure about 0.1 Bar to about 1.0 Bar below a pressure of the ER using an inert gas; and
e) isolating the RF bin from the AF bin, depressurizing the RF bin, and repeating steps a) to d);
f) delivering the AF into an upper end of an extraction reactor (“ER”) and, simultaneously, delivering carbon monoxide gas into a lower end of the ER, wherein the pressure of the ER is maintained at about 5 Bar to about 80 Bar, and wherein the temperature of the ER is maintained at about 60° C. to about 180° C., wherein the ER comprises a flow path directing a downward flow of the AF contrary to an upward flow of the carbon monoxide gas, the flow path enabling the AF to contact the carbon monoxide gas, thereby forming at least one metal carbonyl gas and a solid residue (“R”) therein, and wherein the flow path further directs the upward flow of a produced gas mixture (“PG”) comprising the at least one metal carbonyl gas and, if present, unreacted carbon monoxide gas, and the downward flow of the R;
g) delivering the PG from an upper end of the ER out of an PG port, and, simultaneously, delivering the R from a lower end of the ER by feeding the R to an R bin, wherein the R bin is maintained at a pressure about 0.1 Bar to about 1.0 Bar below a pressure of the ER using an inert gas;
h) delivering the R to a passivated residue (“PR”) bin, wherein the PR bin is maintained at a pressure about the operation pressure of the ER with an inert gas;
i) when the PR bin is full, isolating the PR bin from the R bin and depressurizing the PR bin;
j) perform and, if necessary, repeat until all toxic gas has been removed from the PR bin:
purging the PR bin using nitric oxide, thereby converting any remaining dicobalt octacarbonyl therein to cobalt tricarbonyl nitrosyl gas;
purging the PR bin using an inert gas, thereby removing any volatile cobalt tricarbonyl nitrosyl therein; and
purging the PR bin using an inert gas-oxygen mixture, thereby passivating the R therein to form a passivated residue (“PR”);
k) removing the PR from the PR bin; and
l) purging and pressurizing the PR bin with an inert gas and repeating steps h) to k).

12. The method of claim 11, wherein steps a) to d) are performed using a plurality of RF bins each in turn.

13. The method of claim 12, wherein the method further comprises using a controller to control the cycle of steps a) to d) using the plurality of RF bins.

14. The method of claim 11, wherein steps h) to k) are performed using a plurality of PR bins each in turn.

15. The method of claim 14, wherein the method further comprises using a controller to control the cycle of steps h) to k) using the plurality of PR bins.

16. The method of claim 11, wherein the metal comprises nickel and at least one metal selected from the group consisting of iron, cobalt, and any combination thereof.

17. The method of claim 11, wherein the reduced feed material is an agglomerated feed material, optionally in the form of briquettes and/or pellets.

18. The method of claim 11, wherein the extraction reactor is a shell and tube heat exchanger.

19. The method of claim 11, wherein the method further comprises:
prior to providing the RF, preparing the RF, wherein preparing the RF comprises:
providing an oxidized feed material (“OF”) comprising at least one oxidized metal compound; and
contacting the OF with a reducing agent at a sufficient temperature and for a sufficient time to reduce the OF, thereby forming the RF;
separating nickel carbonyl gas, cobalt carbonyl gas, iron carbonyl gas, or any combination thereof, from the PG; and converting the nickel carbonyl gas, cobalt carbonyl gas, iron carbonyl gas, or any combination into the corresponding metal; and/or
collecting any cobalt tricarbonyl nitrosyl purged from the PR bin; and comprising converting any collected cobalt tricarbonyl nitrosyl into cobalt.

20. The method of claim 19, wherein the OF comprises mixed hydroxide precipitate (MHP).
